(19) United States
(12) Patent Application Publication
(10) Pub. No.: US 2022/0288788 A1
(43) Pub. Date: Sep. 15, 2022

(54) ROBOT AND METHOD FOR CONTROLLING SAME

(71) Applicant: SAMSUNG ELECTRONICS CO., LTD., Suwon-si (KR)

(72) Inventors: Woomok KIM, Suwon-si (KR); Sangyoung HWANG, Suwon-si (KR)

(73) Assignee: SAMSUNG ELECTRONICS CO., LTD., Suwon-si (KR)

(21) Appl. No.: 17/829,753

(22) Filed: Jun. 1, 2022

Related U.S. Application Data
(63) Continuation of application No. PCT/KR2020/010656, filed on Aug. 12, 2020.

(30) Foreign Application Priority Data
Jan. 29, 2020 (KR) 10-2020-0010298

(51) Int. Cl. B25J 9/16

(52) U.S. Cl. CPC B25J 9/1694; B25J 9/1679; B25J 9/161

(57) ABSTRACT

Disclosed are a robot and a method for controlling the robot. The robot includes: a plurality of sensors; a memory which stores a plurality of services and controls commands corresponding to the plurality of services; and a processor which, when the occurrence of an event is sensed on the basis of at least one of the plurality of sensors, determines a service corresponding to the event on the basis of information sensed by the at least one sensor, and controls the robot to provide a user with the determined service. The processor sets a sensing target corresponding to the service determined on the basis of the sensed information, determines a sensor combination for achieving the sensing target set on the basis of the information about the plurality of sensors, and obtains additional information on the basis of the determined sensor combination, and provides the user with the service.

### CROSS-REFERENCE TO RELATED APPLICATIONS

This application is a continuation application of International Application No. PCT/KR2020/010656, filed on Aug. 12, 2020, which claims benefit of priority to Korean Patent Application No. 10-2020-0010298, filed on Jan. 29, 2020, at the Korean Intellectual Property Office, the disclosures of which are incorporated herein in their entireties by reference.

### BACKGROUND

### 1. Field

The disclosure relates to a robot and a control method thereof. More particularly, the disclosure relates to a robot configured to provide, based on detecting an occurrence of an event, a service corresponding to the relevant event and a control method thereof.

### 2. Description of Related Art

A social robot is a robot which engages and interacts with humans through social actions such as language, gesture, and the like, and may specifically refer to a robot configured to provide life assistance, emotional assistance, entertainment, education, guidance, and care services. The social robot of the related art performed interaction with users by using artificial intelligence (AI), big data, Internet of Things (IoT), and cloud computing technology.

However, sensing technology of the social robot of the related art has the limitation of not being able to exceed a Use-Case of directly receiving a request on providing a service from a user from a specific area (e.g., home, office), providing the requested service, and the like.

Accordingly, there is a need for technology in which the social robot not only provides service on the Use-Case, but also autonomously sets a sensing goal and provides service corresponding to the set sensing goal.

### SUMMARY

Aspects of the disclosure are to address at least the above-mentioned problems and/or disadvantages and to provide at least the advantages described below. Accordingly, an aspect of the disclosure is to provide a robot which autonomously sets a sensing goal and a sensor combination, and provides a service based on the set sensing goal and sensor combination and a control method thereof.

According to an example embodiment, a robot includes a plurality of sensors, a memory configured to store a plurality of services and control instructions corresponding to the plurality of services, and a processor configured to determine, based on detecting an occurrence of an event by at least one sensor from among the plurality of sensors, a service corresponding to the event based on information detected by the at least one sensor, and control the robot to provide the determined service to a user, and the processor is configured to set a sensing goal corresponding to the determined service based on the detected information, determine a sensor combination to perform the set sensing goal based on information on the plurality of sensors, and obtain additional information based on the determined sensor combination and provide the determined service to the user.

The processor may be configured to analyze the detected information according to history information including at least one from among a time, a location, a frequency, or a relevant object, and set the sensing goal based on the analyzed detected information.

The processor may be configured to analyze, based on receiving a user command requesting at least one service from among the plurality of services, the user command according to the history information, and set the sensing goal based on the analyzed history information.

The processor may be configured to determine at least one detection role on respective sensors based on another information on the plurality of sensors, and determine the sensor combination based on the determined at least one detection role.

The processor may be configured to identify an external sensor which may be used by the robot, and determine the sensor combination taking into further consideration the external sensor and information of the external sensor.

The processor may be configured to determine the sensor combination based on at least one from among sensing information, location information or use history information of the external sensor.

The processor may be configured to obtain external information from a server, and determine the determined service based on the obtained external information.

The processor may be configured to obtain a priority order on the plurality of services based on a profile classified according to an object for using the robot, and detecting the occurrence of the event based on the obtained priority order.

The processor may be configured to obtain feedback on the set sensing goal or the provided service from the user, and update information on the sensing goal or the provided service based on the feedback.

According to an embodiment, a control method of a robot includes detecting an occurrence of an event by at least one sensor from among a plurality of sensors, determining a service corresponding to the event based on information detected by the at least one sensor, setting a sensing goal corresponding to the determined service based on the detected information, determining a sensor combination to perform the set sensing goal based on information on the plurality of sensors, and providing the determined service to a user by obtaining additional information based on the determined sensor combination.

The setting the sensing goal may include analyzing the detected information according to history information including at least one from among a time, a location, a frequency, or a relevant object, and setting the sensing goal based on the analyzed detected information.

The control method according to an embodiment may further include receiving a user command requesting at least one service from among a plurality of services, and the setting the sensing goal includes analyzing the user command according to the history information, and setting the sensing goal based on the analyzed history information.

The determining the sensor combination may include determining at least one detection role on respective sensors based on another information on the plurality of sensors, and determining the sensor combination based on the determined at least one detection role.

The sensor combination may include identifying an external sensor which may be used by the robot, and determining the sensor combination taking into further consideration the external sensor and information of the external sensor.

The determining the sensor combination may include determining the sensor combination based on at least one from among sensing information, location information or use history information of the external sensor.

The determining the service may include obtaining external information from a server, and determining the determined service based on the obtained external information.

The detecting the occurrence of the event may include obtaining a priority order on a plurality of services based on a profile classified according to an object of using the robot, and detecting the occurrence of the event based on the obtained priority order.

The control method according to an embodiment may further include obtaining feedback on the set sensing goal or the provided service from the user, and updating information on the sensing goal or the provided service based on the feedback.

### BRIEF DESCRIPTION OF THE DRAWINGS

FIG. 1 is a diagram schematically illustrating an operation of a robot according to an embodiment;

FIG. 2 is a block diagram illustrating in brief a configuration of a robot according to an embodiment;

FIG. 3 is a block diagram illustrating in detail a configuration of a robot according to an embodiment;

FIG. 4 is a diagram illustrating a robot system according to an embodiment;

FIG. 5 is a block diagram illustrating a configuration of an external device according to an embodiment;

FIG. 6 is a diagram illustrating an external device disposed spaced apart according to an embodiment;

FIG. 7 is a diagram illustrating a sensor included in an external device according to an embodiment; and

FIG. 8 is a flowchart illustrating a control method of a robot according to an embodiment.

### DETAILED DESCRIPTION

The example embodiments described below are merely exemplary to assist in the understanding of the disclosure, and it is to be understood that various modifications may be made to the example embodiments of the disclosure different from the example embodiments described herein. However, in describing the disclosure, in case it is determined that the detailed description of related known technologies may unnecessarily confuse the gist of the disclosure, the detailed description thereof and the specific illustration thereof will be omitted. In addition, some elements in the enclosed drawings have been illustrated and enlarged in size compared to actual size for convenience of description, and the ratio of each element may be exaggerated or minimized.

In describing the disclosure, the order of each step is to be understood as non-limiting unless the order of each step needs to be performed such that a preceding step must be performed logically and temporally prior to a following step. That is, except for exceptional cases as described above, even if a process described as the following step is performed preceding a process described as the preceding step, it does not influence the nature of the disclosure and the scope of protection should also be defined regardless of the order of the step.

In the disclosure, expressions such as “comprise,” “may comprise,” “include,” “may include,” or the like are used to designate a presence of a corresponding characteristic (e.g., elements such as numerical value, function, operation, or component, etc.), and not to preclude a presence or a possibility of additional characteristics.

Further, because elements necessary to the respective example embodiments are described in the disclosure, the disclosure is not necessarily limited thereto. Accordingly, some elements may be changed or omitted, and other elements may be added. In addition, the elements may be distributed and disposed to an independent device different from one another.

In addition, terms including ordinal numbers such as “first,” “second,” and the like may be used in the disclosure and the claimed scope to differentiate between elements. The ordinal numbers are used to differentiate the same or similar elements from another, and the meaning of the term is not to be interpreted as limiting by the use of the ordinal numbers. In an example, an element coupled with the ordinal number is not to be limited in the order of use, arrangement order, or the like by the use of the number. If necessary, the respective ordinal numbers may be used interchangeably.

In the disclosure, a singular expression includes a plural expression, unless otherwise specified. It is to be understood that the terms such as “comprise” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The terms “module,” “unit,” “part,” or the like used in the example embodiments herein are terms which designate an element that performs at least one function or operation, and the element may be implemented with a hardware or software, or a combination of hardware and software. Further, a plurality of “modules,” a plurality of “units,” or a plurality of “parts”, except for a “module,” “a unit,” or a “part” which needs to be implemented to a specific hardware, may be integrated to at least one module or a chip and implemented in at least one processor.

In addition, when a certain portion is described as coupled with another portion in the example embodiment, this includes not only direct coupling, but also indirect coupling through another medium. In addition, the meaning of the certain portion including another element may refer to another element being further included rather than being excluded, unless otherwise specified.

In the disclosure “learning” or “training” may refer to a process of seeking a weight of which a difference between a value actually output from an artificial neural network and an output value calculated by being calculated in an output layer are minimized.

The disclosure will be described in greater detail below with reference to the accompanying drawings.

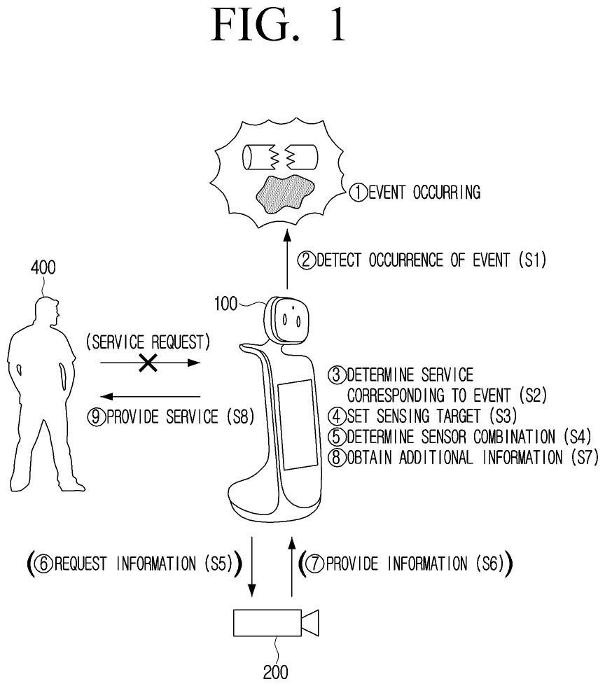

FIG. 1 is a diagram schematically illustrating an operation of a robot according to an example embodiment. In FIG. 1, a user 400, a robot 100, and an external device 200 is illustrated according to an example embodiment.

Referring to FIG. 1, an event may occur in a space in which the robot 100 is present. Then, the robot 100 may be configured to detect the occurrence of the event based on at least one sensor from among the plurality of sensors (S1). For example, the event may be an act of a user 400, or may be a series of cases which occurred in the surroundings of the robot 100. For example, the robot 100 may be configured to detect the occurrence of the event based on information detected through sensors of a camera, a microphone, or the like. Alternatively, the robot 100 may be configured to detect the occurrence of the event through various instances such as sound, illuminance, and vibration meeting and/or exceeding a pre-set numerical value or more.

Then, the robot 100 may be configured to determine a service corresponding to the event based on the detected information (S2). For example, the robot 100 may be configured to detect sound by using a sensor (e.g., microphone) capable of detecting sound, and identify a type of the detected sound. Further, the robot 100 may be configured to identify the type of object which generated the sound by analyzing the detected sound. As illustrated in FIG. 1, the robot 100 may be configured to detect the sound of something breaking, and identify that the detected sound is the sound of a glass cup breaking. Then, the robot 100 may be configured to determine the service to be provided to the user 400 with respect to the occurred event with the notification. For example, the service may be a function of the robot 100 provided to the user 400, and may include provision of information, danger notification, emergency call, security check, and the like. That is, because the service provided by the robot 100 can be changed according to the information obtained by the robot 100, and the use of the robot 100, the embodiment is not limited to the above-described example.

Then, the robot 100 may be configured to set a sensing goal based on the detected information to provide the determined service (S3). Then, the robot 100 may be configured to determine a sensor combination for performing the set sensing goal based on information on the plurality of sensors (S4). For example, based on the robot 100 identifying that the event is a ‘sound of a glass cup breaking’ or ‘sound of something breaking’ based on the detected information, but not being able to identify a ‘location of where the glass cup broke’ or ‘what the broken object is,’ the robot 100 may be configured to set identifying the ‘location of where the glass cup broke’ or ‘what the broken object is’ as a sensing goal. Then, the robot 100 may be configured to determine a vision sensor (e.g., camera) capable of detecting an object and a sensor (e.g., ultrasonic sensor) capable of detecting liquid as the sensor combination for performing the sensing goal.

Then, the robot 100 may be configured to obtain additional information based on the sensor combination for performing the sensing goal (S7), and provide the user 400 with a service corresponding to the occurred event (S8). For example, the robot 100 may be configured to use the vision sensor (e.g., camera) and the sensor (e.g., ultrasonic sensor) capable of detecting liquid to obtain additional information on the ‘location of where the glass cup broke’ or ‘what the broken object is.’ Then, the robot 100 may be configured to notify that a dangerous element has occurred which may inflict damage to the user 400.

The robot 100 may be configured to use the plurality of sensors included in the robot 100 and/or an external sensor included in the external device 200 to determine the sensor combination. Based on the robot 100 determining the external sensor included in the external device 200 as one of the sensors for performing the sensing goal, the robot 100 may be configured to request information to the external device 200 (S5), and the external device 200 may be configured to provide information to the robot 100 (S6). For example, the robot 100 may be configured to request information to the external device 200 which includes the vision sensor, and receive information from the external device 200. Then, the robot 100 may be configured to analyze the information received from the external device 200 to obtain additional information on the occurred event, and provide the user 400 with a service.

The external device 200 described in FIG. 1 may be an electronic device capable of performing communication connections with the robot 100. In an example embodiment, the external device 200 may include at least one from among a smartphone, a tablet personal computer (PC), a video telephone, a smart television (TV), an e-book reader, a desktop PC, a laptop PC, a netbook computer, a workstation, a server, a personal digital assistance (PDA), a portable multimedia player (PMP), an AI speaker, a microphone, a camera, an IoT device, an IoT gateway, or a wearable device.

According to an example embodiment, the robot 100 may be configured to detect the occurrence of an event even if or when the user 400 did not directly request the specific service and autonomously provide the specific service corresponding to the relevant event. Additionally or alternatively, the robot 100 may be configured to autonomously set the sensing goal to provide the specific service corresponding to the event, and determine the sensor combination. However, in FIG. 1, although it has been described assuming that the user 400 has not requested the specific service to the robot 100 for convenience of description, based on the user 400 requesting the specific service to the robot 100, the robot 100 may be configured to provide the specific service requested by the user 400.

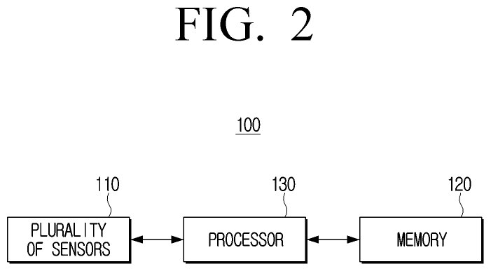

FIG. 2 is a block diagram illustrating in brief a configuration of a robot according to an example embodiment. Referring to FIG. 2, the robot 100 may include a plurality of sensors 110, a memory 120, and a processor 130.

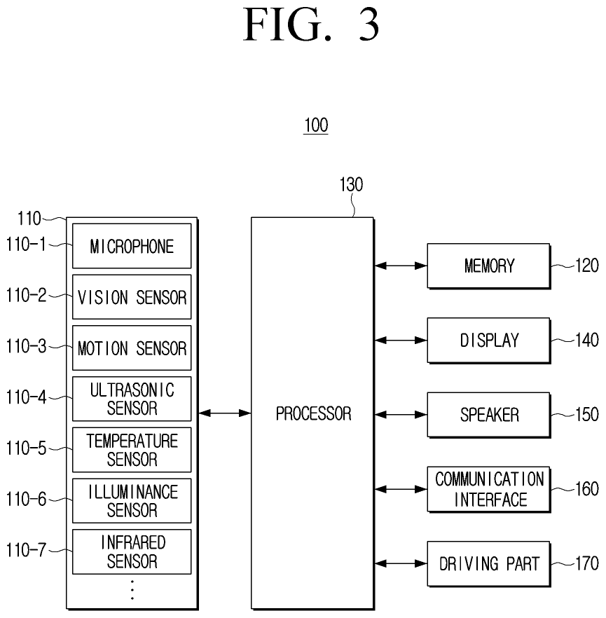

The plurality of sensors 110 may be configured for obtaining various information on the surroundings of the robot 100. The plurality of sensors 110 may be configured to detect physical changes such as heat, light, temperature, pressure, sound, and the like and change to an electrical signal, and obtain various information on the surroundings of the robot 100 based on the changed electrical signal. For example, the robot 100 may be configured to detect a presence of the user 400 who is present at a close location based on the information detected through a light detection and ranging (LIDAR) sensor or an ultrasonic sensor. Additionally or alternatively, the plurality of sensors 110 may include various sensors, and the plurality of sensors 110 will be described in detail with reference to FIG. 3.

The memory 120 may be configured to store instructions or data associated with at least one other element of the robot 100. In some embodiments, the memory 120 may be implemented with a non-volatile memory, a volatile memory, a flash-memory, a hard disk drive (HDD), a solid-state drive (SSD), or the like.

The memory 120 may be accessed by the processor 130, and reading/writing/modifying/deleting/updating and the like of data may be performed by the processor 130. In the disclosure, the term “memory” may include a read only memory (ROM) within the processor 130 (not shown), a random access memory (RAM), or a memory card (not shown, such as a micro SD card, a memory stick) mounted to the robot 100.

In some embodiments, a plurality of services and control instructions corresponding to the plurality of services to provide to the user 400 may be stored in the memory 120. For example, the service may be a function of the robot 100 provided to the user 400, and may include provision of information, danger notification, emergency call, security check, and the like. That is, the service provided by the robot 100 may be changed according to the information obtained by the robot 100, and by the use and function of the robot 100.

Alternatively or additionally, the memory 120 may be configured to store a profile classified according to the object of using the robot 100. For example, the profile may be an operation mode of the robot which is set differently according to the object for using the robot 100. In some embodiments, the profile may include information on a priority order on services provided to the user 400, and as an example, based on the operation mode of the robot being set to a profile (e.g., elderly care) of providing a care-related service to the user 400, the robot 100 may be configured to first provide services such as medication counseling, provision of heath information, danger notification, emergency call to guardian, slippery surface caution notification, and the like.

Additionally or alternatively, the memory 120 may be configured to store information on a space in which the robot 100 is present. The robot 100 may be configured to identify the external device or the external sensor present within a movement range of the robot 100, and store information on the external device 200 or the external sensor in the memory 120. For example, the information on the external device 200 or the external sensor stored in the memory 120 may include attribute information which may include location information, sensing information, use history information, and the like of the respective external devices 200.

Further, the memory 120 may be configured to store information on the plurality of sensors 110 included in the robot 100 and/or information on the external device 200 or the external sensor in the surroundings of the robot 100. In some embodiments, the memory 120 may be configured to store information on an activation condition of the respective sensors 110 included in the robot 100, and/or information on an activation condition of the surrounding external device 200 or external sensor.

Further, the memory 120 may be configured to store data for identifying events which occur at different situations from one another. For example, the memory 120 may be configured to store data according to a pre-trained object recognition model or an object analyzing model, or store data according to a pre-trained sound recognition model or a sound analyzing model, the data of which is data for analyzing the detected sound. Additionally or alternatively, the memory 120 may be configured to store various data for identifying an occurred event.

The processor 130 may be configured for controlling the configurations included in the robot 100. In some embodiments, the processor 130 may be electrically coupled with the robot 100 and configured to control the overall operation and function of the robot 100. For example, the processor 130 may be configured to operate an operating system or an operating program to control hardware or software elements coupled with the processor 130, and perform various data processing and calculations. Additionally or alternatively, the processor 130 may be configured to load instructions or data received from at least one from among the other elements to the volatile memory and process the instructions or data, and store the various data in the non-volatile memory.

To this end, the processor 130 may be implemented as a generic purpose processor (e.g., a central processing unit (CPU) or an application processor) capable of performing relevant operations by executing one or more software programs stored in a dedicated processor for performing the relevant operation or a memory device.

In some embodiments, the processor 130 may be configured to determine whether an event has occurred based on at least one sensor from among the plurality of sensors 110. In some embodiments, the processor 130 may be configured to identify an occurred event and a surrounding situation based on the information detected by at least one sensor from among the plurality of sensors 110. The processor 130 may be configured to analyze the detected information (e.g., detected sound or photographed image) by using an artificial intelligence model. For example, the artificial intelligence model may refer to neurons of a mathematical model being interconnected and forming a network. In some embodiments, the processor 130 may be configured to simulate a neural network structure and function of a creature and use one from among the generated artificial neural networks.

Further, the processor 130 may be configured to obtain a priority order on the plurality of services based on the profile classified according to the object for using the robot 100, and detect the occurrence of the event based on the obtained priority order. For example, the profile may be the operation model of the robot which may be set differently according to the object for using the robot 100. In some embodiments, the profile may include information on the priority order on service provided to the user 400, and for example, based on the operation mode of the robot 100 being set to a profile (e.g., elderly care) of providing a care-related service to the user 400, the processor 130 may be configured to first provide services such as medication counseling, provision of heath information, danger notification, emergency call to guardian, slippery surface caution notification, and the like, and perform an operation for first detecting the occurrence of an event related to the relevant service.

Further, the processor 130 may be configured to compare the information detected by the sensor with the data stored in the memory 120 and identify the occurred event. In some embodiments, the memory 120 may be configured to store data for identifying an event occurring in different situations from one another, and the processor 130 may be configured to identify an event by using the pre-trained object recognition model or the object analyzing model, or by using the pre-trained sound recognition model or the sound analyzing model which is data for analyzing the detected sound.

Further, the processor 130 may be configured to determine the service corresponding to the event. For example, the service may be a function of the robot 100 provided to the user 400, and may include provision of information, danger notification, emergency call, security check, and the like. That is, because the service provided by the robot 100 may be changed according to the information obtained by the robot 100, and according to use of the robot 100, the embodiment is not limited to the above-described example.

Further, the processor 130 may be configured to set the sensing goal corresponding to the service determined based on the detected information. The processor 130 may be configured to obtain information on an initial operating environment of the robot 100, and set a sensing goal based on information on the operating environment and information detected by the sensor. In some embodiments, the processor 130 may be configured to analyze the detected information according to history information which includes at least one from among time, location, frequency, or related object, and set the sensing goal based on the analyzed history information.

The processor 130 may be configured to receive a command from the user 400, and provide a service based on the received command. In some embodiments, based on receiving the user command requesting at least one service from among the plurality of services, the processor 130 may be configured to analyze the user command according to the history information, and set the sensing goal based on the analyzed history information.

For example, analyzing according to the history information by the processor 130 may refer to analyzing information detected by the processor 130 based on a method of five Ws and one H (or, 5W1H). The 5W1H may refer to “who,” “when,” “where,” “what,” “how,” and “why,” and the processor 130 may be configured to analyze the occurred event minimizing user intervention by analyzing the detected information based on 5W1H, and learn the analyzed information. For example, based on an event of a user 400 checking whether a window is open occurring at 8:30 a.m., and the occurred event being detected by the plurality of sensors 110, the processor may be configured to analyze the detected information as “who: the user, when: before the user goes to work, where: in the kitchen, what: the window, how: check whether or not it is open, why: for security.” Then, the processor 130 may be configured to set the sensing goal of checking “whether the window is open before the user goes to work” based on the analyzed information.

The processor 130 may be configured to determine the sensor combination for performing the sensing goal set based on information on the plurality of sensors 110. In some embodiments, the processor 130 may be configured to determine at least one detection role on the respective sensors based on information on the plurality of sensors 110. For example, the robot 100 may include a microphone, and the processor 130 may be configured to determine a first role from among the detection roles as “measure sound and detect sound,” and determine a second role as “detect direction and location of occurred sound” based on information on the microphone. Alternatively, the robot 100 may include an ultrasonic sensor, and the processor may be configured to determine a first role from among the detection roles as “measure distance,” and determine a second role as “detect liquid” based on information on the ultrasonic sensor. However, this is merely an example embodiment according to the disclosure, and it is to be understood that the technical features are not limited to the above-described example, and the role of the respective sensors may be variously set at implementation.

Further, the processor 130 may be configured to determine the sensor combination based on the determined detection role, and obtain additional information based on the determined sensor combination to control the respective configurations of the robot 100 so as to provide service to the user 400.

The processor 130 may be configured to identify a usable external sensor, and determine the sensor combination taking into further consideration the external sensor and information of the external sensor. For example, the information of the external sensor may refer to sensing information associated with an object detected by the external sensor or the detected type of data, location information associated with the location of the external sensor, or the use history information associated with information used connected to the robot 100.

The processor 130 may be configured to obtain external information from the external server, and determine service to be provided to the user 400 based on the obtained external information. For example, the processor 130 may be configured to receive environment information (e.g., weather forecast, etc.) of an area in which the user 400 is present from the news or the internet, and the processor 130 may be configured to determine the service (e.g., weather forecast notification) to be provided to the user 400 based on environment information.

The processor 130 may be configured to obtain feedback on the set sensing goal or the provided service from the user 400, and update information on the sensing goal or the provided service based on the feedback. The processor 130 may be configured to modify the wrongly set sensing goal through the feedback and update, and because the processor 130 is able to understand satisfaction on the provided service, a customized service may be provided to the user 400.

FIG. 3 is a block diagram illustrating in detail a configuration of a robot according to an example embodiment. Referring to FIG. 3, the robot 100 may include a display 140, a speaker 150, a communication interface 160, and a driving part 170 in addition to the plurality of sensors 110, the memory 120, and the processor 130. Because the plurality of sensors 110, the memory 120, and the processor 130 have been described in detail with reference to FIG. 2, redundant descriptions will be omitted.

The plurality of sensors 110 may be configured to detect physical changes such as heat, light, temperature, pressure, sound, and the like and change to an electrical signal, and obtain various information on the surroundings of the robot 100 based on the changed electrical signal. Further, the plurality of sensors 110 may include a microphone 110-1, a vision sensor 110-2, a motion sensor 110-3, an ultrasonic sensor 110-4, a temperature sensor 110-5, an illuminance sensor 110-6, an infrared sensor 110-7, an acceleration sensor (not shown), a gyro sensor (not shown), and the like.

The microphone 110-1 may be a sensor configured to detect sound and output a different value according to the sound. For example, the microphone may be implemented as a dynamic microphone, a condenser microphone, and the like, and may be a device for detecting sound on an audible frequency. The microphone 110-1 may be included in the robot 100 in plurality, and may be configured to compare magnitudes of sound received through the respective microphones to detect the direction of sound.

The vision sensor 110-2 may be a sensor for detecting an object. For example, the vision sensor 110-2 may include at least one from among a camera, a radar sensor, a LIDAR sensor, an ultrasonic sensor, an RF sensor, or a depth sensor. Based on the vision sensor 110-2 being a type of a transmissive radar, even an object located behind an obstacle may be recognized, but based on the vision sensor 110-2 being a type of a low-power radar, accurate detection may not be possible in regions where shadow is formed (e.g., behind obstacle).

The motion sensor 110-3 may be a sensor for detecting movement. The motion sensor 110-3 may be a sensor used in detecting movement of a user 400 or movement of an object.

The ultrasonic sensor 110-4 may be a sensor for measuring distance using a non-audible frequency or detecting an object. For example, the ultrasonic sensor 110-4 may be a type of an active sensor and may be configured to transmit a specific signal and measure the distance by way of measuring a Time of Flight (ToF). For example, the ToF is a time-of-flight distance measurement method, and may be a method of measuring distance by measuring a time difference between a reference point at which a pulse is emitted and a point-in-time at which the pulse is reflected back from a measurement object and detected.

The temperature sensor 110-5 may be a sensor configured to detect heat and generate an electrical signal. The temperature sensor 110-5 may be configured to detect temperature by using the nature of electrical properties changing according to temperature.

The illuminance sensor 110-6 may be a sensor configured to measure brightness of light. The illuminance sensor 110-6 may refer to a sensor configured to measure the brightness of light using a light-dependent resistor in which the resistance changes according to the brightness of light.

The infrared sensor 110-7 may refer to a device configured to detect a physical quantity or chemical quantity of temperature intensity, pressure intensity, radiation intensity, or the like by using infrared rays and convert the physical quantity or chemical quantity to an electrical quantity. The infrared sensor 110-7 may be used to detect an object when illuminance is low (e.g., night).

Although an example embodiment of a plurality of sensors 110 which may be included in the robot is illustrated in FIG. 3, the embodiment is not limited thereto when implemented, and a sensor for identifying an action of the user 400 or detecting surrounding situations may be further included. For example, the robot 100 may be configured to identify the surrounding situation by using an acceleration sensor, a gas sensor, a dust sensor, and the like.

The display 140 may be configured to display various information according to the control of the processor 130. In some embodiments, the display 140 may be configured to provide the service provided to the user 400 in a text or an image. The display 140 may be implemented to a display of various forms such as, for example, and without limitation, a liquid crystal display (LCD), light emitting diodes (LEDs), organic light emitting diode (OLEDs), a Liquid Crystal on Silicon (LCoS), a Digital Light Processing (DLP), or the like. Additionally or alternatively, a driving circuit implementable in the form of an amorphous silicon (a-Si) Thin Film Transistor (TFT), a low temperature poly silicon (LTPS) TFT, an organic TFT (OTFT), or the like, a backlight unit, and the like may also be included in the display 140. Additionally or alternatively, the display 140 may be implemented as a touch screen coupled with a touch panel. However, this is merely one example embodiment, and the display may be variously implemented.

The speaker 150 may be a configuration which outputs various audio data to which various processing operations such as decoding, amplifying, and noise filtering have been performed by an audio processing part, and/or various notification sounds or voice messages. In some embodiments, the speaker 150 may be used to provide a service on a specific event. For example, the robot 100 may be configured to output a voice message in a natural language form by using the speaker 150 for the service of providing information to the user 400. Meanwhile, the configuration for outputting audio may be implemented with the speaker 150, but this is merely one example embodiment, and may be implemented as an output terminal capable of outputting audio data.

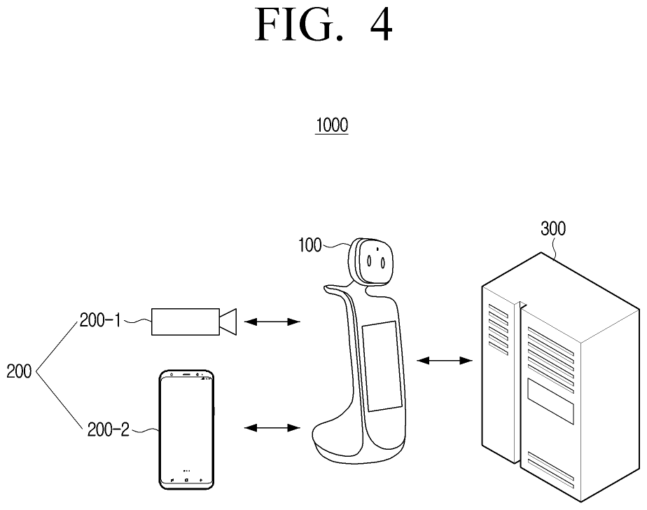

The communication interface 160 may include various communication modules for performing communication with the external device 200 or a server (e.g., server 300 of FIG. 4). For example, the communication interface 160 may include a near field communication (NFC) module (not shown), a wireless communication module (not shown), an infrared module (not shown) and a broadcast receiving module (not shown). The communication interface 160 may be coupled with the external device through a wired method and/or a wireless communication method such as, for example, and without limitation, Wireless LAN (WLAN), Wireless Fidelity (Wi-Fi), Digital Living Network Alliance (DLNA), High Speed Downlink Packet Access (HSDPA), High Speed Uplink Packet Access (HSUPA), Long Term Evolution (LTE), LTE-A, Bluetooth, radio-frequency identification (RFID), infrared communication, ZigBee, and the like.

The communication interface 160 may use various communication modules to perform communication with the external device 200 or the server 300. The communication interface 160 may be configured to receive information from the external device 200 or the server 300 to provide to the user 400.

The driving part 170 may be configured for controlling the motion or movement of the robot 100. Further, the driving part may be configured to control a moving mechanism of the robot 100, and drive/control the relevant configuration by being electrically connected with the mechanical configuration which embodies a physical movement of the robot 100. For example, based on being implemented as a form of the robot 100 in FIG. 1, the driving part 170 may be configured to control the mechanical configuration which controls a wheel of the robot 100, a rotation of a head of the robot 100, or the like. Additionally or alternatively, if or when separate configurations such as an arm or a leg are included in the robot 100, the driving part 170 may be implemented to control the movement of the arm and the leg.

FIG. 4 is a diagram illustrating a robot system according to an embodiment.

Referring to FIG. 4, a robot system 1000 may include the robot 100, the external device 200, and the server 300. Further, the robot 100 may be configured to use the communication interface 160 to perform communication with the external device 200 and/or the server 300. The robot 100 may be configured to obtain information for providing a service by using the external sensor included in the external device 200 to provide service to the user 400. In some embodiments, the robot 100 may be configured to identify the external device 200 and/or the external sensor present in the surroundings of the robot 100. Further, the robot 100 may directly connect with the external device 200, or use the external sensor by using an IoT device (e.g., IoT gateway)(not shown). For example, a first external device 200-1 may be implemented as a camera, and the first external device 200-1 may be indirectly connected to the robot 100 through the IoT device (e.g., IoT gateway). Alternatively, a second external device 200-2 may be implemented as a smartphone, and the second external device 200-2 may be directly connected to the robot 100 using short-range communication, or the like.

Further, the robot 100 may be configured to receive information of the external device 200 and/or the external sensor from the external device 200, and determine the sensor combination for performing the sensing goal taking into further consideration the external device 200 and/or the external sensor. In some embodiments, the robot 100 may be configured to receive information of the external sensor including at least one from among the sensing information, the location information or the use history information of the external sensor from the external device 200. For example, the information of the external sensor may refer to the sensing information associated with the object detected by the external sensor or the detected data type, the location information associated with the location of the external sensor, or the use history information associated with the information used connected to the robot 100.

The robot 100 may be configured to obtain external information from the server 300, and determine service to be provided to the user 400 based on the obtained external information. For example, the robot 100 may be configured to receive environment information (e.g., weather forecast, etc.) of an area in which the user 400 is present from the news or the internet, and the robot 100 may be configured to determine the service (e.g., weather forecast notification) to be provided to the user 400 based on the environment information.

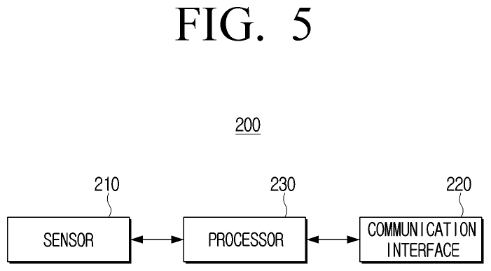

FIG. 5 is a block diagram illustrating a configuration of an external device according to an embodiment.

Referring to FIG. 5, the external device 200 may include a sensor 210, communication interface 220, and a processor 230. In an example embodiment, the external device 200 may include at least one from among a smartphone, a tablet PC, a video telephone, a smart TV, an e-book reader, a desktop PC, a laptop PC, a netbook computer, a workstation, a server, a PDA, a PMP, an AI speaker, a microphone, a camera, an IoT device, an IoT Gateway, or a wearable device.

The sensor 210 may be configured for obtaining various information on the surroundings of the external device 200. In some embodiments, the sensor 210 may be configured to detect physical changes such as heat, light, temperature, pressure, sound, and the like and change to an electrical signal, and obtain various information on the surroundings of the external device 200 based on the changed electrical signal.

The communication interface 220 may be configured for coupling with the robot 100. In some embodiments, the communication interface 220 may be configured for receiving an information request from the robot 100, and transmitting the requested information to the robot 100. To this end, the communication interface 220 may include various communication modules. For example, the communication interface 220 may include an NFC module (not shown), a wireless communication module (not shown), an infrared module (not shown), and a broadcast receiving module (not shown). The communication interface 220 may be coupled with the robot 100 through a wired method and/or a wireless communication method such as, for example, and without limitation, WLAN, Wi-Fi, DLNA, HSDPA, HSUPA, LTE, LTE-A, Bluetooth, RFID, infrared communication, ZigBee, and the like.

The communication method of the robot 100 and the external device 200 may be a method of using mobile communication network such as 3rd generation (3G) and 4th generation (4G), a method of using ZigBee, Bluetooth, InfraRed (IR) which is a short-range wireless communication method, a method of using Wi-Fi, a method of using a wired network, and the like. However, this is merely one example embodiment, and the robot 100 and the external device 200 may be communicatively connected in various methods. That is, the communication interface 220 may be configured to perform communication with the robot 100 using various communication modules, and the communication interface 220 may be configured to transmit information for providing to the user 400 to the robot 100.

Further, the communication interface 220 being communicatively connected with the robot 100 may include communicating through a third device (e.g., a relay, a hub, an access point, a server, a gateway, etc.).

The processor 230 may be electrically connected with respective configurations of the external device 200 and control the overall operation and function of the external device 200. For example, the processor 230 may be configured to drive the operating system or the operation program to control the hardware or software elements connected to the processor 230, and perform various data processing and calculations. Additionally or alternatively, the processor 230 may be configured to load the instructions and data received from at least one from among the other elements to the volatile memory and process the received instructions and data, and store the various data in the non-volatile memory.

In some embodiments, the processor 230 may be configured to control the external device 200 to detect the information requested from the robot 100. Then, the processor 230 may be configured to control the communication interface 220 to transmit the detected information to the robot 100.

Although FIG. 5 illustrates the external device 200 according to an example embodiment in a form including a sensor 210, a communication interface 220, and a processor 230 for convenience of description, the embodiment is not limited to the above-described configuration, and the communication interface 220 or the processor 230 may be omitted according to the type of the external device 200, and some configurations may be further included.

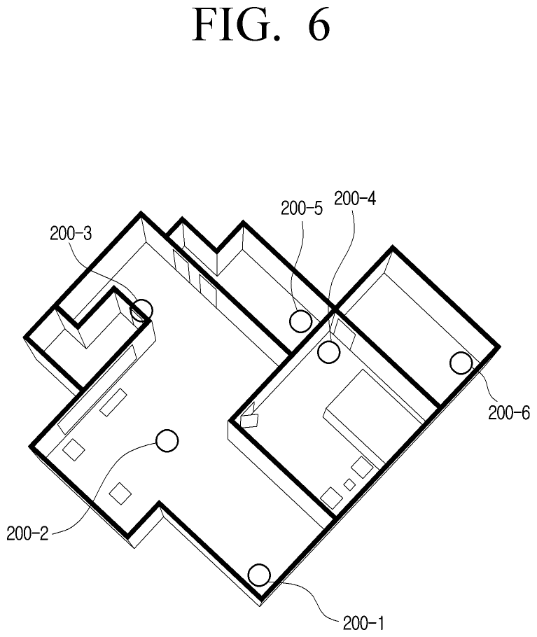

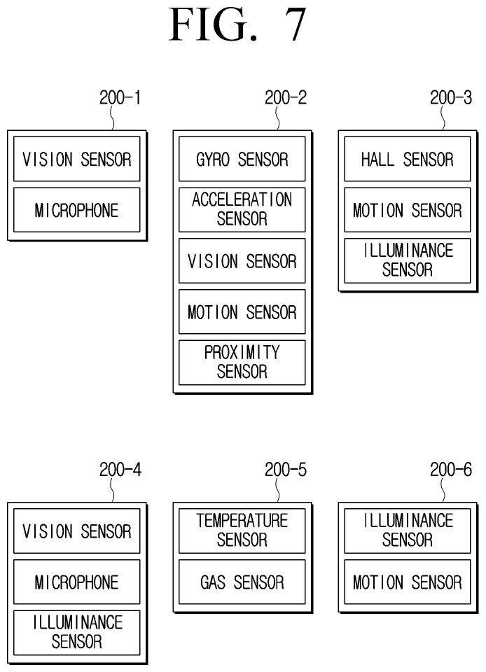

FIGS. 6 and 7 are diagrams illustrating an external device disposed spaced apart according to an embodiment.

Referring to FIG. 6, in a space in which the robot 100 is present, six external devices 200-1 to 200-6 may be provided. In some embodiments, a first external device 200-1, a second external device 200-2, and a third external device 200-3 may be provided in a living room, and a fourth external device 200-4 may be provided in a room, a fifth external device 200-5 may be provided in a kitchen, and a sixth external device 200-6 may be provided in a bathroom. Further, the first to sixth external devices 200-1 to 200-6 may include the plurality of sensors as illustrated in FIG. 7.

In some embodiments, the first external device 200-1 may include the vision sensor and the microphone, the second external device 200-2 may include the gyro sensor, the acceleration sensor, the vision sensor, the motion sensor, and the proximity sensor, the third external device 200-3 may include a hall sensor, the motion sensor, and the illuminance sensor, the fourth external device 200-4 may include the vision sensor, the microphone, and the illuminance sensor, the fifth external device 200-5 may include the temperature sensor and the gas sensor, and the sixth external device 200-6 may include the illuminance sensor and the motion sensor.

The first to sixth external devices 200-1 to 200-6 may include different sensors respectively, and the robot 100 may be configured to identify the information of the external sensors included in the respective external devices from the first to sixth external devices. Further, the robot 100 may be configured to determine the sensor combination for performing the sensing goal set based on information of the external sensor.

For example, based on the robot 100 detecting sound, determining “providing information on the event occurred in the bathroom” as service to be provided to the user 400 based on the detected sound, and setting the “identifying the event occurred in the bathroom” as the sensing goal, the robot 100 may be configured to determine the vision sensor, the microphone, and the motion sensor as the sensor combination for performing the sensing goal. The robot 100 may be configured identify that the sixth external device 200-6 is provided in the bathroom, and that the motion sensor included in the sixth external device 200-6 may be used based on the location information on the external sensor received from the external devices 200-1 to 200-6. Further, the robot 100 may be configured to use the vision sensor and the microphone included in the robot 100 with the motion sensor included in the sixth external device 200-6 to “identify the event occurred in the bathroom,” and provide the service of “providing information on the event occurred in the bathroom” to the user 400. That is, the robot 100 may be configured to use the location information of the external device 200, and obtain additional information by using the external device 200 provided at the location corresponding to the sensing goal.

The first to sixth external devices 200-1 to 200-6 may be flexibly provided at specific locations according to the type of the external device 200. For example, the second external device 200-2 may be a robot cleaner, and may include the feature of not being provided fixed to a specific location, and moving according to time. The robot 100 may be configured to identify an appearance and disappearance pattern and a movement route of the second external device 200-2, and receive surrounding information of the second external device 200-2 based on the appearance and disappearance pattern and the movement route of the second external device 200-2.

According to another example embodiment, the robot 100 may be configured to determine at least one detection role on the respective sensors based on information on the sensor. Further, the robot 100 may be configured to determine the sensor combination based on the at least one detection role on the respective sensors. For example, the robot 100 may be configured to identify that the first external device 200-1 is provided in the living room, and the fourth external device 200-4 is provided in the room based on information on the first external device 200-1 and the fourth external device 200-4. Further, the robot 100 may be configured to use the microphone included in the first external device 200-1 and the fourth external device 200-4 as the device for detecting the location of the occurrence of the event. That is, the robot 100 may be configured to determine the detection role of the microphone with noise measurement and not voice input, and determine the sensor combination based on the determined detection role.

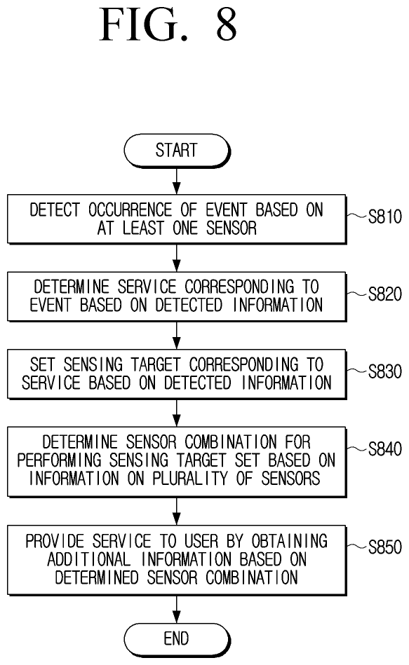

FIG. 8 is a flowchart illustrating a control method of a robot according to an embodiment.

If or when the occurrence of an event is detected based on at least one sensor from among the plurality of sensors included in the robot 100 (S810), the robot 100 may be configured to determine the service corresponding to the event based on the information detected by the at least one sensor (S820). For example, the robot 100 may be configured to detect the occurrence of the event based on the profile classified according to the object for using the robot 100. The profile may be the operation model of the robot which may be set differently according to the object for using the robot 100. In some embodiments, the profile may include information on the priority order on service provided to the user 400, and for example, based on the operation mode of the robot 100 being set to a profile (e.g., elderly care) of providing a care-related service to the user 400, the robot 100 may be configured to first provide services such as medication counseling, provision of information, danger notification, emergency call to guardian, slippery surface caution notification, and the like.

Then, the robot 100 may be configured to set the sensing goal corresponding to the service determined based on the detected information (S830). In some embodiments, the robot 100 may be configured to analyze the detected information according to the history information which includes at least one from among the time, the location, the frequency, or the relevant object, and set the sensing goal based on the analyzed history information. According to another example embodiment, the robot 100 may be configured to receive the user command requesting at least one service from among the plurality of services, analyze the user command according to the history information, and set the sensing goal based on the analyzed history information. For example, the robot 100 analyzing according to the history information may refer to analyzing the detected information based on 5W1H. The 5W1H may refer to “who,” “when,” “where,” “what,” “how,” and “why,” and the robot 100 may be configured to analyze the occurred event minimizing user intervention by analyzing the detected information based on 5W1H, and learn the analyzed information.

Then, the robot 100 may be configured to determine the sensor combination for performing the sensing goal set based on information on the plurality of sensors (S840). In some embodiments, the robot 100 may be configured to determine at least one detection role on the respective sensors based on information on the plurality of sensors, and determine the sensor combination based on the determined detection role. Alternatively, the robot 100 may be configured to identify the external sensor which may be used by the robot 100, and determine the sensor combination taking into further consideration the external sensor and information of the external sensor. For example, the information of the external sensor may include the sensing information, the location information, or the use history information of the external sensor.

Then, the robot 100 may be configured to provide service to the user 400 by obtaining additional information based on the determined sensor combination (S850).

The robot 100 may be configured to obtain external information from the server, and determine service based on the obtained external information.

The robot 100 may be configured to obtain feedback on the set sensing goal or the provided service from the user 400, and update information on the sensing goal or the provided service based on feedback.

The term “part” or “module” used in the disclosure may include a unit configured as a hardware, software, or firmware, and may be used interchangeably with terms such as, for example, and without limitation, logic, logic blocks, components, circuits, or the like. A “part” or “module” may be a component integrally formed or a minimum unit or a part of the component performing one or more functions. For example, a module may be configured as an application-specific integrated circuit (ASIC).

The various example embodiments may be implemented with software including instructions stored in a machine-readable storage media (e.g., computer). The machine may call an instruction stored in the storage medium, and as a device capable of operating according to the called instruction, may include an electronic device according to the described example embodiments. Based on the instruction being executed by the processor, the processor may directly or using other elements under the control of the processor perform a function corresponding to the instruction. The instructions may include a code generated by a compiler or executed by an interpreter. The machine-readable storage medium may be provided in the form of a non-transitory storage medium. Herein, ‘non-transitory’ merely means that the storage medium is tangible and does not include a signal, and the term does not differentiate data being semi-permanently stored or being temporarily stored in the storage medium.

Respective elements (e.g., a module or a program) according to various example embodiments may be comprised of a single entity or a plurality of entities, and some sub-elements of the abovementioned corresponding sub-elements may be omitted, or different sub-elements may be further included in the various example embodiments. Alternatively or additionally, some elements (e.g., modules or programs) may be integrated into one entity to perform the same or similar functions performed by the respective corresponding elements prior to integration. Operations performed by a module, a program, or another element, in accordance with various example embodiments, may be performed sequentially, in a parallel, repetitively, or in a heuristically manner, or at least some operations may be performed in a different order, omitted or a different operation may be added.

What is claimed is:

1. A robot, comprising:
a plurality of sensors;
a memory configured to store a plurality of services and a plurality of control instructions corresponding to the plurality of services; and
a processor configured to determine, based on detecting an occurrence of an event by at least one sensor from among the plurality of sensors, a service corresponding to the event based on information detected by the at least one sensor, and control the robot to provide the determined service to a user,
wherein the processor is further configured to set a sensing goal corresponding to the determined service based on the detected information, determine a sensor combination to perform the set sensing goal based on information on the plurality of sensors, and obtain additional information based on the determined sensor combination and provide the determined service to the user.

2. The robot of claim 1, wherein the processor is further configured to analyze the detected information according to history information comprising at least one from among a time, a location, a frequency, or a relevant object, and set the sensing goal based on the analyzed detected information.

3. The robot of claim 2, wherein the processor is further configured to analyze, based on receiving a user command requesting at least one service from among the plurality of services, the user command according to the history information, and set the sensing goal based on the analyzed history information.

4. The robot of claim 1, wherein the processor is further configured to determine at least one detection role on respective sensors based on another information on the plurality of sensors, and determine the sensor combination based on the determined at least one detection role.

5. The robot of claim 1, wherein the processor is further configured to identify an external sensor usable by the robot, and determine the sensor combination taking into further consideration the external sensor and information of the external sensor.

6. The robot of claim 5, wherein the processor is further configured to determine the sensor combination based on at least one from among sensing information, location information or use history information of the external sensor.

7. The robot of claim 1, wherein the processor is further configured to obtain external information from a server, and determine the determined service based on the obtained external information.

8. The robot of claim 1, wherein the processor is further configured to obtain a priority order on the plurality of services based on a profile classified according to an object for using the robot, and detecting the occurrence of the event based on the obtained priority order.

9. The robot of claim 1, wherein the processor is further configured to obtain feedback on the set sensing goal or the provided service from the user, and update information on the sensing goal or the provided service based on the feedback.

10. A control method of a robot, the method comprising:
detecting an occurrence of an event by at least one sensor from among a plurality of sensors;
determining a service corresponding to the event based on information detected by the at least one sensor;
setting a sensing goal corresponding to the determined service based on the detected information;
determining a sensor combination to perform the set sensing goal based on information on the plurality of sensors; and
providing the determined service to a user by obtaining additional information based on the determined sensor combination.

11. The method of claim 10, wherein the setting the sensing goal comprises analyzing the detected information according to history information comprising at least one from among a time, a location, a frequency, or a relevant object, and setting the sensing goal based on the analyzed detected information.

12. The method of claim 11, further comprising:
receiving a user command requesting at least one service from among a plurality of services,
wherein the setting the sensing goal comprises analyzing the user command according to the history information, and setting the sensing goal based on the analyzed history information.

13. The method of claim 10, wherein the determining the sensor combination comprises determining at least one detection role on respective sensors based on another information on the plurality of sensors, and determining the sensor combination based on the determined at least one detection role.

14. The method of claim 10, wherein the determining the sensor combination comprises identifying an external sensor useable by the robot, and determining the sensor combination taking into further consideration the external sensor and information of the external sensor.

15. The method of claim 14, wherein the determining the sensor combination comprises determining the sensor combination based on at least one from among sensing information, location information or use history information of the external sensor.
